(19) United States
(12) Patent Application Publication
(10) Pub. No.: US 2026/0143558 A1
(43) Pub. Date: May 21, 2026

(54) PREVENTING PACKET RE-ORDERING OVER MULTI-CARRIER FIFTH GENERATION NON-TERRESTRIAL NETWORK SATELLITE CELLS

(71) Applicants: AT&T Intellectual Property I, L.P., Atlanta, GA (US); AT&T Technical Services Company, Inc., Vienna, VA (US)

(72) Inventors: Daniel Vivanco, Ashburn, VA (US); David Ross Beppler, Duluth, GA (US); Thomas W. Henderson, Alpharetta, GA (US)

(21) Appl. No.: 18/951,236

(22) Filed: Nov. 18, 2024

(51) Int. Cl. H04W 76/28; H04L 47/62; H04W 84/06

(52) U.S. Cl. CPC H04W 76/28; H04L 47/62; H04W 84/06

(57) ABSTRACT

A method includes detecting, in a non-terrestrial satellite cell of a wireless communications network in which micro discontinuous transmission is enabled in a forward-link path, an instance of a plurality of data packets belonging to a same transmission being split among a plurality of component carriers of the non-terrestrial satellite cell, identifying, for a user endpoint device from which the same transmission is being transmitted, a micro discontinuous transmission setting for each component carrier of the plurality of component carriers, estimating a packet re-ordering density for the plurality of data packets based on the micro discontinuous transmission setting, determining that the packet re-ordering density is greater than a threshold density, and instructing at least one component carrier of the plurality of component carriers to adjust the micro discontinuous transmission setting associated with the at least one component carrier so that the packet re-ordering density is reduced.

The present disclosure relates generally to mobile networks and relates more particularly to devices, non-transitory computer-readable media, and methods for preventing packet re-ordering over multi-carrier Fifth Generation (5G) non-terrestrial network (NTN) satellite cells.

### BACKGROUND

In the field of mobile networking, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs.

### SUMMARY

In one example, the present disclosure describes a device, computer-readable medium, and method for preventing packet re-ordering over multi-carrier Fifth Generation (5G) non-terrestrial network (NTN) satellite cells. For instance, in one example, a method includes detecting, in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell, identifying, for a user endpoint device from which the same transmission is being transmitted, a micro discontinuous transmission setting for each component carrier of the plurality of component carriers, estimating a packet re-ordering density for the plurality of data packets based on the micro discontinuous transmission setting, determining that the packet re-ordering density is greater than a threshold density, and instructing at least one component carrier of the plurality of component carriers to adjust the micro discontinuous transmission setting associated with the at least one component carrier so that the packet re-ordering density for the plurality of data packets is reduced.

In another example, a non-transitory computer-readable medium stores instructions which, when executed by a processor, cause the processor to perform operations. The operations include detecting, in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell, identifying, for a user endpoint device from which the same transmission is being transmitted, a micro discontinuous transmission setting for each component carrier of the plurality of component carriers, estimating a packet re-ordering density for the plurality of data packets based on the micro discontinuous transmission setting, determining that the packet re-ordering density is greater than a threshold density, and instructing at least one component carrier of the plurality of component carriers to adjust the micro discontinuous transmission setting associated with the at least one component carrier so that the packet re-ordering density for the plurality of data packets is reduced.

In another example, a device includes a processor and a computer-readable medium storing instructions which, when executed by the processor, cause the processor to perform operations. The operations include detecting, in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell, identifying, for a user endpoint device from which the same transmission is being transmitted, a micro discontinuous transmission setting for each component carrier of the plurality of component carriers, estimating a packet re-ordering density for the plurality of data packets based on the micro discontinuous transmission setting, determining that the packet re-ordering density is greater than a threshold density, and instructing at least one component carrier of the plurality of component carriers to adjust the micro discontinuous transmission setting associated with the at least one component carrier so that the packet re-ordering density for the plurality of data packets is reduced.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a diagram showing the transmission of five example data packets by a satellite receiver without micro discontinuous transmission;

FIG. 3 illustrates a diagram showing how data transmissions may be delivered in a multi-carrier fifth generation non-terrestrial network such as the network of FIG. 1;

FIG. 4 illustrates a flowchart of an example method for preventing packet re-ordering over multi-carrier Fifth Generation non-terrestrial network satellite cells, in accordance with the present disclosure; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure describes a device, computer-readable medium, and method for preventing packet re-ordering over multi-carrier Fifth Generation (5G) non-terrestrial network (NTN) satellite cells. As discussed above, non-terrestrial networks (NTNs) are networks for which at least a portion of the physical infrastructure is not anchored to the Earth's surface. NTNs stand in contrast to terrestrial networks (TNs), which are networks for which a majority, if not all, of the physical infrastructure is anchored to the Earth's surface. For instance, NTNs include satellite networks and networks that utilize unmanned aerial vehicles or high-altitude platform systems to provide broadband links, while TNs include Fourth Generation long term evolution (4G LTE) and Wi-Fi networks. NTNs are considered to be one of the major pillars of Fifth Generation (5G), Sixth Generation (6G), and next-generation mobile networks due to their ability to extend mobile network coverage to locations that are currently underserved by TNs. In one example of the present disclosure, an NTN may be used to extend the mobile coverage of an LTE or 5G network.

For instance, a mobile network operator may utilize an NTN to extend the coverage of a TN into a geographic area in which it may be impractical or infeasible to deploy the necessary TN infrastructure (such as a remote, uninhabited, or sparsely inhabited geographic area). In this case, the coverage of the TN may be extended using a direct cellular-to-satellite NTN. Cellular-to-satellite NTNs can create a direct connection from a user's standard cellular telephone (e.g., using LTE, 5G, global system for mobile communications (GSM), universal mobile telecommunications system (UMTS), 6G, or other commercially available cellular technologies) to a satellite, as long as the satellite is using frequency bands that the cellular telephone is already designed to communicate with. Direct cellular-to-satellite service may also enable rapid deployment of temporarily extended network coverage during periods of heavy network traffic and/or in emergency situations such as natural disasters, accidents, and the like. Direct cellular-to-satellite service may thus enhance commercial, emergency, and first responder broadband communication systems.

Satellite cells may have the ability to use one or more cells, and to operate at different frequency bands (e.g., B5, B14, etc.). For instance, different frequency bands may be used in different locations. An operator of a wireless network may have the ability to mandate satellite cells to change frequency bands to avoid interference with terrestrial cells, which may operate in the same frequency band(s).

In some examples, direct cellular-to-satellite service may use multi-carrier 5G NTN satellite cells to provide capacity and coverage to terrestrial user endpoint devices. The carriers of these multi-carrier 5G NTN satellite cells may use the same frequency band (intra-band) or different frequency bands (inter-band) and may support carrier aggregation. Some or all of the carriers may support micro discontinuous transmission (μDTX) mechanisms with the same or similar μDTX settings. μDTX is an energy saving mode deployed in cellular base stations that switches off subparts of radio units during empty radio frequency (RF) symbols.

Under the assumptions above, data forwarded from a base station (e.g., gNodeB) to a user endpoint device may first be received at the terrestrial base station and split into a primary cell (PCell) and one or more secondary cells (SCells). Subsequently, data streams may be transmitted to the multi-carrier 5G NTN satellite cell. The PCell and SCell(s) may have μDTX enabled with different settings and/or may enter energy saving mode at different times, such that the data scheduling time at different carriers may not align with each other. As a result, data packets delivered by one component carrier of the satellite cell may arrive later that other consecutive data packets delivered by other component carriers of the satellite cell. In other words, the data packets may be received out of order at the user endpoint device, necessitating packet re-ordering. Transmission control protocol (TCP) may interpret packet re-ordering as one or more lost packets and may request retransmission of any packets believed to have been lost.

Packet re-ordering over multi-carrier 5G NTN satellite cells with carrier aggregation and μDTX enabled may be more noticeable in cases of bursty traffic, since the component carriers may tend to enter power amplifier off cycles more frequently. In addition, cases of high-order carrier aggregation may actually increase packet re-ordering density (i.e., the ratio of the number of out of order packets in a group of packets to the total number of packets in the group of packets).

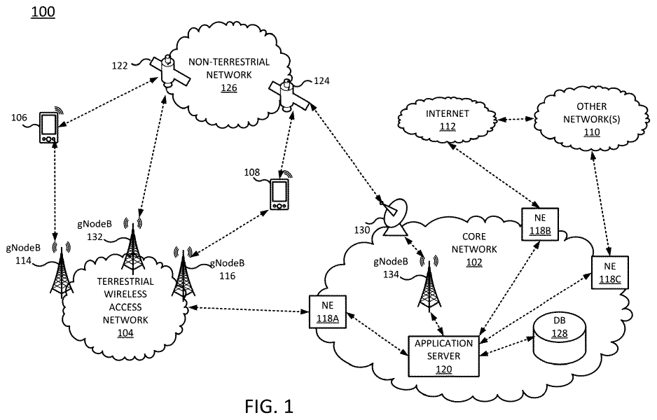

Examples of the present disclosure detect when a multi-carrier 5G NTN satellite cell with carrier aggregation and μDTX enabled is splitting data packets of a common transmission among multiple component carriers. When such a situation is detected, and the packet re-ordering density exceeds a predefined threshold density, examples of the present disclosure may instruct the component carriers to adjust their μDTX settings so that data streams being transmitted by different component carriers are delivered to a user endpoint device with smaller time gaps between the data streams. Minimizing the time gaps will minimize or completely avoid packet re-ordering, which in turn will reduce the number of presumed lost packets for which retransmission is requested, and ultimately conserve energy at the terrestrial base station. These and other aspects of the present disclosure are discussed in greater detail in connection with FIGS. 1-5, below.

To better understand the present disclosure, FIG. 1 illustrates an example network 100, related to the present disclosure. As shown in FIG. 1, the network 100 connects mobile devices 106 and 108, as well as potentially other devices, with one another and with various other devices via a core network 102, a wireless access network 104 (e.g., a cellular network), other networks 110 and/or the Internet 112.

In one example, wireless access network 104 may comprise a terrestrial network, such as a radio access network implementing such technologies as: GSM, e.g., a base station subsystem (BSS), or IS-95, a UMTS network employing wideband code division multiple access (WCDMA), or a CDMA3000 network, among others. In other words, wireless access network 104 may comprise an access network in accordance with any 2G, 3G, 4G, LTE, 5G, next-generation radio access network (NG-RAN), or any other yet to be developed future wireless/cellular network technology including beyond 5G (e.g., 6G) and further generations. While the present disclosure is not limited to any particular type of wireless access network, in the illustrative example, wireless access network 104 is shown as a UMTS terrestrial radio access network (UTRAN) subsystem. Thus, elements 114, 116, and 132 may each comprise a next generation Node B (gNodeB).

In one example, each of the mobile devices 106 and 108 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker, a pair of smart glasses or goggles, etc.), a gaming console, a drone, an autonomous vehicle (e.g., automobile, watercraft, or aircraft), and the like. In one example, any one or more of the mobile devices 106 and 108 may have both cellular and non-cellular access capabilities and may further have wired communication and networking capabilities.

As illustrated in FIG. 1, network 100 includes a core network 102. In one example, core network 102 may combine core network components of a cellular network with components of a triple play service network; where triple play services may include telephone services, Internet services and television services to subscribers. For example, core network 102 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 102 may also further comprise a broadcast television network, e.g., a traditional cable provider network or an Internet Protocol Television (IPTV) network, as well as an Internet Service Provider (ISP) network. The network elements 118A-118C may serve as gateway servers or edge routers to interconnect the core network 102 with other networks 110, Internet 112, wireless access network 104, other access networks, and so forth.

The core network 102 may also comprise an application server (AS) 120 and a database (DB) 128 that may be configured to detect when a multi-carrier 5G NTN satellite cell of the network 100 with carrier aggregation and μDTX enabled is splitting data packets of a common transmission among multiple component carriers. When such a situation is detected, and the packet re-ordering density exceeds a predefined threshold density, examples of the present disclosure may instruct the component carriers to adjust their μDTX settings so that data streams being transmitted by different component carriers are delivered to a mobile device 106 or 108 with smaller time gaps between the data streams, as discussed in further detail below.

In one example, a cellular base station (e.g., a gNodeB) 134 may communicatively couple the AS 102 to a satellite receiver 130 (which may also function as a gNodeB of an NTN 126) of the core network 102. The base stations 132 and 134 may be implemented within the satellites 122 and 124, respectively, or between the satellite receiver 130 and the core network 102 (e.g., the application server 120) to convert the analog waveforms of cellular transmissions into digital format in the downlink (and to make the opposite conversion for the uplink). For ease of illustration, various additional elements of core network 102 are omitted from FIG. 1. For instance, core network 102 may also include other network elements that are not illustrated, such as television (TV) servers, content servers, application servers, and the like.

In addition, the network 100 may include the non-terrestrial network 126 that functions in a manner similar to the terrestrial wireless access network 104. For instance, the non-terrestrial network 126 may comprise an access network that provides broadband links via satellite, unmanned aerial vehicles, high-altitude platform systems, or any other yet to be developed future wireless/non-terrestrial network technologies. While the present disclosure is not limited to any particular type of non-terrestrial network, in the illustrative example, non-terrestrial network 126 is shown as a satellite network. Thus, elements 122 and 124 may each comprise a satellite, such as a low earth orbit (LEO) satellite. In one example, multiple satellites deployed in a batch (as in the case of satellites 122 and 124) may be referred to as a “constellation.” In a constellation, each satellite 122 and 124 may have a predefined coverage area or cell (e.g., a fifty km radius). Satellite cells of the NTN 126 may be arranged in a specific formation to provide continuous coverage to terrestrial mobile devices 106 and 108. A constellation of satellite cells can provide a larger continuous coverage area proportional to the number of satellite cells in the constellation.

In a 5G NTN, the base station or baseband unit (BBUs) of a gNodeB is located in the terrestrial gateway (e.g., satellite receiver 130 of core network 102), while the remote radio unit (RRU) of the gNodeB is located in a satellite 122 or 124. The downlink waveform is transmitted from the terrestrial gateway to the satellite cell counterpart (e.g., a remote radio unit, which may be part of a satellite 122 or 124) as an analog waveform through microwave transmissions, downconverted to a cellular frequency, and transmitted from the satellite 122 or 124 to the terrestrial mobile device 106 or 108. Similarly, the uplink waveform is transmitted from a terrestrial mobile device 106 or 108 to the satellite cell as a cellular waveform, upconverted to a microwave frequency, and transmitted to the eNodeB or gNodeB in the terrestrial gateway (e.g., satellite receiver 130). Satellite cells may use one set of high-power amplifiers (not shown) to amplify the received waveforms from the terrestrial gateway and another set of high-power amplifiers to transmit the converted downlink waveforms to the terrestrial mobile devices 106 and 108.

In other examples, the eNodeBs, gNodeBs, and other cellular site equipment may be part of the satellite platform, and the feeder link to the terrestrial gateway may carry the backhaul in S1 mode, N1, mode, or in another format. In one example, the non-terrestrial network 126 may be controlled and/or operated by the same mobile network operator as the terrestrial wireless access network 104. In another example, the non-terrestrial network 126 may be controlled and/or operated by a different entity than the mobile network operator who operates the terrestrial wireless access network 104.

In one particular example, the non-terrestrial network 126 may utilize radio frequency bands that are also utilized by the terrestrial wireless access network 104 (e.g., radio frequency bands that are licensed by the mobile network operator who operates the terrestrial wireless access network 104). As such, the terrestrial wireless access network 104 and the non-terrestrial network 126 may operate in a co-channel arrangement.

In general, each of the base stations 114, 116, 130, 132, and 134 may comprise a radio unit and a power amplifier. The radio unit generates and decodes waveforms, while the power amplifier amplifies the power to transmit the waveforms (and can also be used on the receiver side). The power generated by the power amplifier will depend on the desired coverage. In one example, the satellite receiver 130 (and, optionally, one or more other base stations 114, 116, 132, and 134) may utilize μDTX. μDTX will turn power amplifier paths off autonomously, per orthogonal frequency-division multiple access (OFDMA) symbol, when there is no data for the satellite receiver 130 to transmit. Without μDTX, the radio unit and power amplifier may both be set to “ON,” regardless of whether there is data for the satellite receiver 130 to transmit. However, as long as the power amplifier is powered on, the power amplifier will consume energy, even during idle periods where there is no data to transmit.

When μDTX is employed, rather than sending multiple relatively small data packets in multiple data transmissions (e.g., as the data packets are received), the satellite receiver 130 may buffer the small, non-delay sensitive data packets into fewer, larger data transmissions (delay-sensitive packets may still be transmitted as the packets are received, regardless of size).

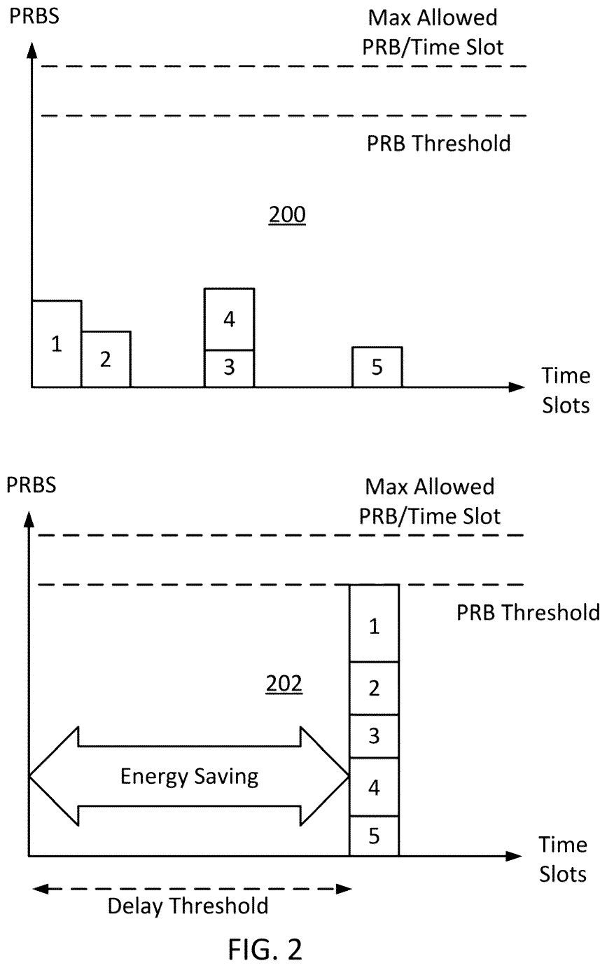

FIG. 2, for instance, illustrates a diagram 200 showing the transmission of five example data packets (labeled 1-5) by the satellite receiver 130 without μDTX. As illustrated, the data packets are transmitted more or less individually during different time slots (with the exception of data packets 3-4 which are transmitted simultaneously). As such, there is little to no idle time during which the power amplifier of the satellite receiver 130 may be powered off. Moreover, because the idle time between the transmissions is so relatively small, repeatedly powering the power amplifier on and off to transmit the data packets may waste energy.

The diagram 202 of FIG. 2, however, shows how using μDTX may enable the satellite receiver 130 to conserve energy. As illustrated in the diagram 202, the satellite receiver 130 may wait until the last data packet (e.g., data packet 5) is received, and then transmit all of the data packets 1-5 in the same time slot. This allows the satellite receiver 130 to send data transmissions with less frequency, and to power the power amplifier off for longer periods of time when no data transmissions are being sent, thereby minimizing the amount of energy consumed to send the data packets.

A goal of μDTX is to prioritize reducing energy consumption and maximizing full-cell bandwidth over low cell utilization and delivery of data in small chunks. A challenge of μDTX is that numerous smaller data packets and channels may occupy a large portion of the transmit time, even if user plane data volumes are relatively low. Thus, μDTX may attempt to predict idle periods in which the radio unit of a base station can switch off the power amplifier.

In some examples, μDTX may determine when to deliver groups of data packets based on a physical resource block (PRB) threshold and a delay threshold. μDTX will then deliver a group of data packets that has been buffered as soon as one of the following conditions is met: (1) the time for which the oldest data packet of the group of data packets has been buffered meets the delay threshold; (2) a delay-sensitive data packet arrives in the queue and must be delivered right away (or with a very short delay), with all the currently buffered data packets; or (3) the summation of the combined PRBs of the group of data packets has met the PRB threshold. In one example μDTX may be configured so that the PRB threshold equals the maximum number of allowed PRBs per time slot. Alternatively, μDTX may be configured so that the PRB threshold is less than the maximum number of allowed PRBs per time slot (e.g., 90% of the maximum number of allowed PRBs per time slot).

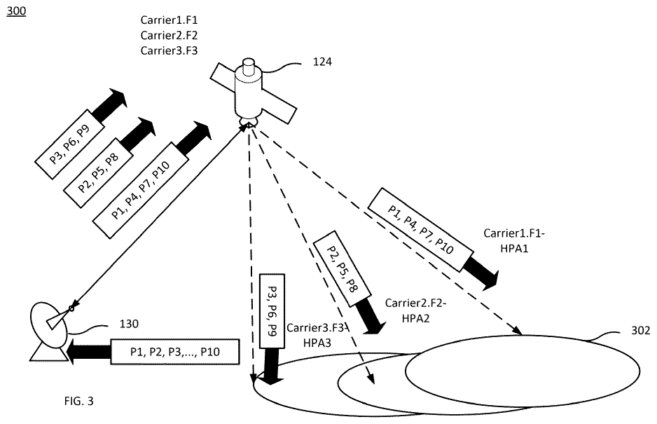

FIG. 3 illustrates a diagram 300 showing how data transmissions may be delivered in a multi-carrier 5G NTN such as the network 100. As discussed above, forward data in the form of a series of packets (e.g., P1-P10) from a gNodeB (e.g., gNodeB 134 of FIG. 1) to a mobile device (e.g., mobile device 108 of FIG. 1) may first be received at the satellite receiver/gNodeB 130. The satellite receiver 130 may support three component carriers (Carrier1, Carrier2, and Carrier3) engaged in carrier aggregation, and may split the series of packets among the three carriers. In one example, a first data stream comprising packets P1, P4, P7, and P10 is allocated to Carrier1; a second data stream comprising packets P2, P5, and P8 may be allocated to Carrier2; and a third data stream comprising packets P3, P6, and P9 may be allocated to Carrier3.

Subsequently, the satellite receiver 130 may forward the data streams to a multi-carrier 5G NTN satellite cell 302 served by a satellite of the NTN 126 (e.g., satellite 124). The data streams may be forwarded to the satellite cell 302 at the same time or at different times. Carrier1, Carrier2, and Carrier3 may have μDTX enabled with different settings and/or may enter energy saving mode at different times, such that the data scheduling time at the different carriers may not align with each other. As a result, the data stream delivered by one component carrier (e.g., Carrier1) of the satellite cell 302 may arrive later that other data streams delivered by other component carriers (e.g., Carrier2 and Carrier3) of the satellite cell 302. For instance, Carrier3 may deliver its data stream first, followed by Carrier1, and then Carrier2, such that the series of data packets may be received in the following order (with gaps in between streams): P3, P6, P9, GAP, P1, P4, P7, P10, GAP, P2, P5, P8.

If the gaps between the data streams is small, then the application on the mobile device 108 may be able to resolve the packet re-ordering. However, if the gaps are large, then the application on the mobile device 108 may not be able to resolve the packet re-ordering and may need to request retransmission if one or more of the packets P1-P10.

In one example, the AS 120 may be configured to detect when data packets of a common transmission are being split among multiple component carriers of the multi-carrier 5G NTN satellite cell 302 while μDTX is enabled. When such conditions are detected by the AS 120, the AS 120 may identify the component carriers that are participating in carrier aggregation for the mobile device 108 (which may be transmitting data in carrier aggregation mode) and monitor the data scheduling times of the component carriers.

The AS 120 may further estimate the packet re-ordering density for the data that is being transmitted in carrier aggregation mode. If the estimated packet re-ordering density is higher than a predefined threshold density, then the AS 104 may instruct the component carriers to adjust their μDTX settings so that the data streams associated with the different component carriers are delivered with smaller gaps of time between delivery (or even no gaps between delivery, so that all data streams associated with all component carriers are delivered simultaneously). As a result, packet re-ordering may be minimized or avoid, thus minimizing the need to request retransmissions of packets.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 102 is not limited to an IMS network. Wireless access network 104 is not limited to a UMTS/UTRAN configuration. Non-terrestrial network 126 is not limited to a satellite network. Similarly, the present disclosure is not limited to an IP/MPLS network for VoIP telephony services, or any particular type of broadcast television network for providing television services, and so forth.

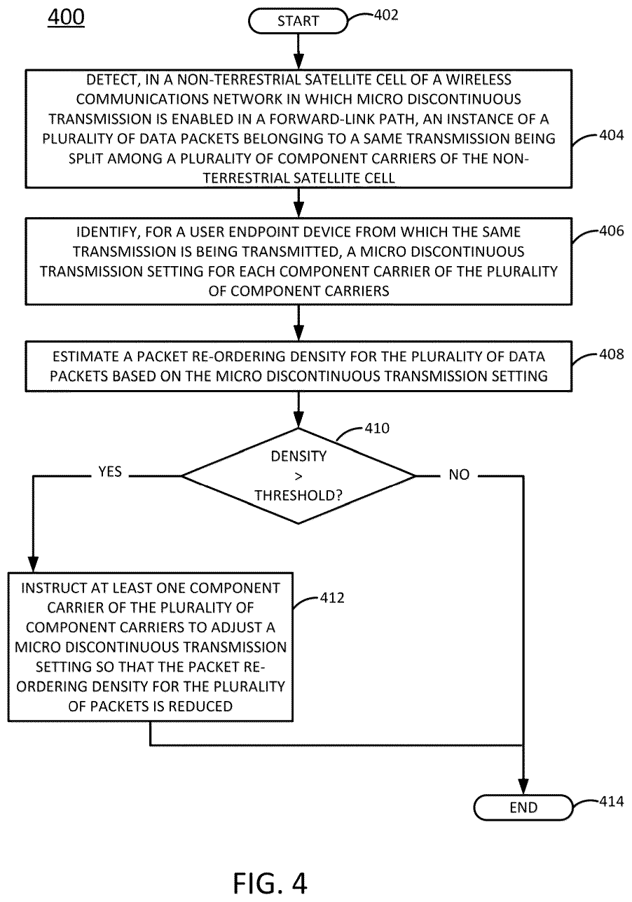

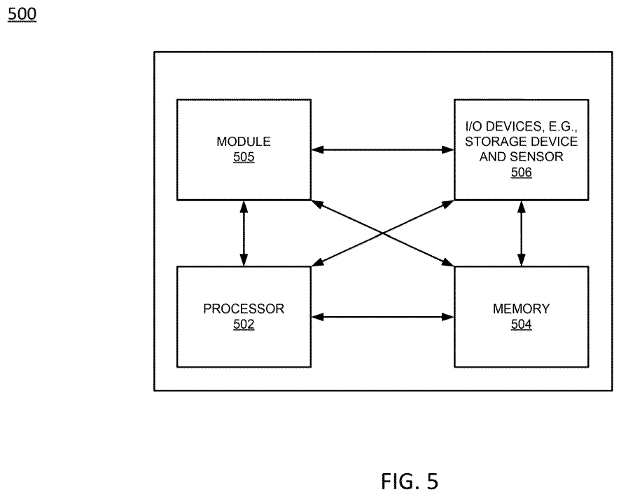

To further aid in understanding the present disclosure, FIG. 4 illustrates a flowchart of an example method 400 for preventing or minimizing packet re-ordering over multi-carrier Fifth Generation non-terrestrial network satellite cells, in accordance with the present disclosure. In one example, the method 400 may be performed by a self-optimized network (SON) controller, a RAN intelligent controller (RIC), or application server of a mobile network operator core network, such as the AS 120 illustrated in FIG. 1. However, in other examples, the method 400 may be performed by another device, such as the processor 502 of the system 500 illustrated in FIG. 5. For the sake of example, the method 400 is described as being performed by a processing system.

The method 400 begins in step 402. In step 404, the processing system may detect, in a non-terrestrial satellite cell of a wireless communications network in which micro discontinuous transmission is enabled in the forward-link path, an instance of a plurality of data packets belonging to a same transmission being split among a plurality of component carriers of the non-terrestrial satellite cell.

In one example, the satellite cell may be part of a 5G NTN in which direct cellular-to-satellite communications are supported. The satellite cell may support carrier aggregation, and, as a result when the plurality of packets is received by a terrestrial base station for transmission to a mobile device via the satellite cell, the terrestrial base station may split the plurality of packets into a plurality of data streams. Each data stream may be delivered to the satellite cell via a different component carrier of the plurality of component carriers.

In one embodiment, the μDTX may be configured in the forward-link path as an energy efficiency tool to mandate KEY-OFF radio components per OFDMA symbol level when there is no data to transmit to a terrestrial user terminal.

In step 406, the processing system may identify, for a user endpoint device from which the same transmission is being transmitted, a micro discontinuous transmission setting for each component carrier of the plurality of component carriers.

In one example, the μDTX setting may include a scheduling time for each component carrier of the plurality of component carriers. That is, the processing system may determine a time at which each component carrier of the plurality of component carriers is scheduled to transmit a respective data stream of the plurality of data streams. In another example, the μDTX setting may comprise a time interval at which each component carrier of the plurality of component carriers KEYS-OFF its corresponding radio components, so that at the expiration of the time interval, a subset of the plurality of data packets is scheduled to be sent to a terrestrial user terminal. In this case, data transmissions to the terrestrial user terminal may have been split among the plurality of component carriers (which have μDTX enabled); as a result, data streams may be received at the terrestrial user terminal (from the plurality of component carriers) with time gaps between the data streams, which may necessitate packet re-ordering at the terrestrial user terminal.

As discussed above, μDTX may allow the different data streams to be transmitted at either the same time or at different times. Thus, depending on the scheduling of the different component carriers, the plurality of data streams may be scheduled for transmission from the satellite cell to the mobile device at different times. This may cause the data packets to be received out of order at the mobile device.

It should be noted that a scheduling time for a component carrier may change at any time, especially if new data packets arrive at the terrestrial base station for transmission to the mobile device, and the new data packets have different requirements with respect to buffering time (e.g., as may be the case with Voice over IP (VoIP) packets and other types of data packets). These new data packets may be destined for the mobile device or for another mobile device being served by the same satellite cell.

In step 408, the processing system may estimate a packet re-ordering density for the plurality of data packets based on the micro discontinuous transmission setting.

In one example, the packet re-ordering density may be estimated based on the scheduling of the plurality of component carriers, as determined in step 406. As discussed above, packet re-ordering density may be estimated as the ratio of the number of out of order packets of the plurality of packets to the total number of packets in the plurality of packets. For instance, based on the scheduling of the plurality of component carriers, the processing system may determine that x out of a total of y data packets will be delivered out of order at the mobile device. Thus, the packet re-ordering density in this case may be x/y.

In step 410, the processing system may determine whether the packet re-ordering density is greater than a threshold density.

In one example, the threshold density is a maximum packet re-ordering density. The maximum packet re-ordering density may be configurable and may be defined by an operator of the wireless communications network. For instance, defining a lower threshold may allow for less packet re-ordering to occur (and therefore lead to potentially fewer packet retransmission requests), but with more intervention by the processing system. A higher threshold may allow for more packet re-ordering (and therefore lead to potentially more packet retransmission requests), but with less intervention by the processing system.

If the processing system concludes in step 410 that the packet re-ordering density is not greater than the threshold density, then the processing system may take no further action, and the method 400 may simply end in step 414.

Thus, if the packet re-ordering density is determined to not be greater than the threshold density, then the component carriers may be allowed to proceed with scheduling according to the existing μDTX settings of the component carriers.

If, however, the processing system concludes in step 410 that the packet re-ordering density is greater than the threshold density, then the method 400 may proceed to step 412. In step 412, the processing system may instruct at least one carrier of the plurality of carriers to adjust its respective micro discontinuous transmission setting so that the packet re-ordering density for the plurality of data packets is reduced. In other words, the processing system may instruct at least one system or device that is utilizing at least one component carrier of the plurality of component carriers to adjust at least one respective μDTX setting so that the data stream being transmitted by different component carriers are delivered to a user endpoint device with smaller time gaps between the data streams.

By reducing the time gap between transmissions of the plurality of data packets (e.g., between delivery of two data streams of the plurality of data streams), the number of requests for packet retransmissions by the mobile device may be minimized, because the mobile device will need to rely less heavily on packet re-ordering (if at all). In one example, reducing the time gap may result in at least two component carriers of the plurality of component carriers scheduling transmission of their respective data packets simultaneously (e.g., such that the time gap is reduced to zero or near zero).

In one example, the processing system may instruct all of the component carriers to adjust their respective μDTX settings. For instance, in one example, the adjustment may comprise disabling μDTXin all of the component carriers to reduce or eliminate (e.g., reduce to zero) the time gap in the next data scheduling cycle.

Once the processing system has instructed the at least one carrier accordingly, the method 400 may end in step 414.

Although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 400 may be implemented as the system 500. For instance, an application server (such as might be used to perform the method 400) could be implemented as illustrated in FIG. 5.

As depicted in FIG. 5, the system 500 comprises a hardware processor element 502, a memory 504, a module 505 for preventing packet re-ordering over multi-carrier Fifth Generation non-terrestrial network satellite cells, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for preventing packet re-ordering over multi-carrier Fifth Generation non-terrestrial network satellite cells may include circuitry and/or logic for performing special purpose functions relating to estimating a packet re-ordering density of a series of packets being delivered via carrier aggregation and with μDTX enabled and adjusting μDTX settings of component carriers. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for preventing packet re-ordering over multi-carrier Fifth Generation non-terrestrial network satellite cells (e.g., a software program comprising computer-executable instructions) can be loaded into memory 504 and executed by hardware processor element 502 to implement the steps, functions or operations as discussed above in connection with the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for preventing packet re-ordering over multi-carrier Fifth Generation non-terrestrial network satellite cells (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
detecting, by a processing system including at least one processor in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell;
identifying, by the processing system for a user endpoint device from which the same transmission is being transmitted, a micro discontinuous transmission setting for each component carrier of the plurality of component carriers;
estimating, by the processing system, a packet re-ordering density for the plurality of data packets based on the micro discontinuous transmission setting;
determining, by the processing system, that the packet re-ordering density is greater than a threshold density; and
instructing, by the processing system, at least one component carrier of the plurality of component carriers to adjust the micro discontinuous transmission setting associated with the at least one component carrier so that the packet re-ordering density for the plurality of data packets is reduced.

2. The method of claim 1, wherein the satellite cell is part of a fifth generation non-terrestrial network in which direct cellular-to-satellite communications are supported.

3. The method of claim 1, wherein the micro discontinuous transmission setting is configured in the forward-link path as an energy efficiency tool to mandate key-off radio components per orthogonal frequency-division multiple access symbol level, when there is no data to transmit to a terrestrial user terminal.

4. The method of claim 3, wherein the micro discontinuous transmission setting is different for at least two component carriers of the plurality of component carriers.

5. The method of claim 3, wherein the micro discontinuous transmission setting comprises a time interval at which each component carrier keys-off corresponding radio components, wherein at an expiration of the time interval a subset of the plurality of data packets is scheduled to be sent to a terrestrial user terminal.

6. The method of claim 1, wherein the packet re-ordering density comprises a ratio of a number of out of order data packets of the plurality of data packets to a total number of data packets in the plurality of data packets.

7. The method of claim 1, wherein the threshold density is configurable.

8. The method of claim 1, wherein the threshold density is defined by an operator of the wireless communications network.

9. The method of claim 1, wherein a time gap is reduced to a duration that minimizes a need for packet re-ordering at a terrestrial user terminal that receives transmissions of the plurality of data packets.

10. The method of claim 9, wherein the instructing causes the transmissions to be scheduled for simultaneous transmission by respective component carriers of the plurality of component carriers.

11. The method of claim 1, wherein the processing system instructs all component carriers of the plurality of component carriers to adjust the micro discontinuous transmission setting to reduce a time gap between transmissions of the plurality of component carriers.

12. The method of claim 11, wherein the instruction causes the all component carriers to disable the micro discontinuous transmission during a subsequent data scheduling cycle to eliminate a time gap between transmissions of the plurality of component carriers.

13. The method of claim 1, wherein a data transmission to a terrestrial user terminal is split among the plurality of component carriers, wherein the micro discontinuous transmission is enabled for the plurality of component carriers, and wherein data streams are received at the terrestrial user terminal with time gaps between the data streams to cause packet re-ordering at the terrestrial user terminal

14. A non-transitory computer-readable medium storing instructions which, when executed by a processing system including at least one processor, cause the processing system to perform operations, the operations comprising:
detecting, in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell
identifying, for a user endpoint device from which the same transmission is being transmitted, a micro discontinuous transmission setting for each component carrier of the plurality of component carriers;
estimating a packet re-ordering density for the plurality of data packets based on the micro discontinuous transmission setting;
determining that the packet re-ordering density is greater than a threshold density; and
instructing at least one component carrier of the plurality of component carriers to adjust the micro discontinuous transmission setting associated with the at least one component carrier so that the packet re-ordering density for the plurality of data packets is reduced.

15. The non-transitory computer-readable medium of claim 14, wherein the micro discontinuous transmission setting is configured in the forward-link path as an energy efficiency tool to mandate key-off radio components per orthogonal frequency-division multiple access symbol level, when there is no data to transmit to a terrestrial user terminal.

16. The non-transitory computer-readable medium of claim 15, wherein the micro discontinuous transmission setting is different for at least two component carriers of the plurality of component carriers.

17. The non-transitory computer-readable medium of claim 14, wherein the packet re-ordering density comprises a ratio of a number of out of order data packets of the plurality of data packets to a total number of data packets in the plurality of data packets.

18. The non-transitory computer-readable medium of claim 14, wherein a time gap is reduced to a duration that minimizes a need for packet re-ordering at a terrestrial user terminal that receives transmissions of the plurality of data packets.

19. The non-transitory computer-readable medium of claim 14, wherein the processing system instructs all component carriers of the plurality of component carriers to adjust the micro discontinuous transmission setting, and wherein the instruction causes the all component carriers to disable the micro discontinuous transmission during a subsequent data scheduling cycle.

20. A device comprising:
a processing system including at least one processor; and
a computer-readable medium storing instructions which, when executed by the processing system, cause the processing system to perform operations, the operations comprising:
detecting, in a non-terrestrial satellite cell of a wireless communications network in which a micro discontinuous transmission is enabled in a forward-link path, an instance of a plurality of data packets belonging to a same transmission being split among a plurality of component carriers of the non-terrestrial satellite cell;
identifying, for a user endpoint device from which the same transmission is being transmitted, a micro discontinuous transmission setting for each component carrier of the plurality of component carriers;
estimating a packet re-ordering density for the plurality of data packets based on the micro discontinuous transmission setting;
determining that the packet re-ordering density is greater than a threshold density; and
instructing at least one component carrier of the plurality of component carriers to adjust the micro discontinuous transmission setting associated with the at least one component carrier so that the packet re-ordering density for the plurality of data packets is reduced.
